(19) United States
(12) Patent Application Publication
(10) Pub. No.: US 2007/0183572 A1
(43) Pub. Date: Aug. 9, 2007

(54) Apparatus and method for manufacturing a mandibular advancement device

(76) Inventors: Arielle Drummond, Pittsburgh, PA (US); Prakash Somasundaram, Pittsburgh, PA (US); Minette Vaccariello, Pittsburgh, PA (US); Jaewon Kang, Pittsburgh, PA (US); Catherine Sun, Cambridge, MA (US); Andrew Concilio, Pittsburgh, PA (US); Jason DePerro, Toledo, OH (US); Andrew Petruska, Liverpool, NY (US)

Correspondence Address: MICHAEL W. HAAS;RESPIRONICS, INC., 1010 MURRY RIDGE LANE, MURRYSVILLE, PA, 15668, US

(21) Appl. No.: 11/499,113

(22) Filed: Aug. 4, 2006

Related U.S. Application Data
(60) Provisional application No. 60/758,822, filed on Jan. 13, 2006.

(51) Int. Cl. H05G 1/64

(52) U.S. Cl. 378/98.8

(57) ABSTRACT

The present disclosure relates to a method for treating sleep disorders using an intra-oral appliance and to the fabrication of an intra-oral appliance that incorporates digital information into the process so as to increase efficiency and decrease cost. The method includes a data capture step and a fabrication step.

### CROSS-REFERENCE TO RELATED APPLICATIONS

This application claims priority under 35 U.S.C. §119(e) from provisional U.S. patent application No. 60/758,822, filed Jan. 13, 2006, the contents of which are incorporated herein by reference.

### BACKGROUND OF THE INVENTION

1. Field of the Invention

The present invention relates to an apparatus and method for manufacturing a device used for treating sleep and other respiratory disorders.

2. Description of the Related Art

Snoring and obstructive sleep apnea are typically caused by complete or partial obstruction of an individual's pharyngeal airway during sleep. In many instances, airway obstruction results from the apposition of the rear portion of the tongue or soft palate with the posterior pharyngeal wall. Obstructive sleep apnea is a disorder in which breathing stops during sleep for 10 seconds or more, sometimes up to 300 times per night. Snoring occurs when the pharyngeal airway is partially obstructed resulting in vibration of the oral tissues during respiration. These sleep disorders tend to become more severe as patients grow older, likely due to a progressive loss of muscle tone in the patient's throat and oral tissues.

Intra-oral devices for treating these conditions are known. One such device provides an upper bite block that engages the teeth on the upper jaw (maxilla), a lower bite block that engages the teeth on the lower jaw (mandible), and a coupling device that couples the lower bite block to the upper bite block in a manner such that the lower bite block and hence the patient's lower jaw is maintained in a protruded position relative to the upper jaw. Positioning a patient's jaw in this manner has been shown to increase the volume of the airway during sleep by causing the pharyngeal passage to avoid blockage by the tongue or other tissue, thereby reducing the occurrence of obstructive sleep apnea and snoring.

The present invention relates to an improved method of manufacture of devices of this type. The present invention also relates to apparatuses for manufacturing devices of this type.

### SUMMARY OF THE INVENTION

The present disclosure describes a method of forming an appliance for treating obstructive sleep apnea, snoring, or other respiratory disorders by controlling the position of the mandible relative to the maxilla. The method comprises acquiring electronic information relating to a patient's maxillary and mandibular dentitions. The electronic information is used to fabricate an upper shell for the patient's maxillary dentition and a lower shell for the patient's mandibular dentition, each of the shells being formed of a first material and having a channel therein, a coupling device being provided on the upper shell and the lower shell for maintaining the lower shell in a forwardly protruded position with respect to the upper shell, when taken in relation to the corresponding natural position of the patient's mandibular and maxillary dentitions. A moldable second material is supplied to each of the channels and is shaped to substantially conform to the patient's maxillary and mandibular dentitions.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an ”, and “the” include plural referents unless the context clearly dictates otherwise

### BRIEF DESCRIPTION OF THE DRAWINGS

FIG. 1 shows a mandibular advancement device manufactured in accordance with an embodiment of the present invention;

FIG. 2 is a flow diagram of the major steps of the fabrication process of the mandibular advancement device of FIG. 1;

FIG. 3 is a view of a Data Capture Unit used in the method of manufacture in accordance with one embodiment of the invention, shown in a first orientation;

FIG. 4 is a view of the Data Capture Unit of FIG. 3 in a second orientation;

FIG. 5 shows four images taken by the Data Capture Unit of FIG. 3;

FIG. 6 shows an optical impression device used in accordance with one embodiment of the present invention;

FIG. 7 shows a virtual model obtained using the optical impression system of FIG. 6;

FIG. 8 shows a computer console with drawing tablet for use in a parameter definition step in accordance with one embodiment of the present invention;

FIG. 9 is a screenshot of parameter definition software used in the method of manufacture;

FIG. 10 is a screenshot of the parameter definition software of FIG. 9, showing a dental professional defining various parameters;

FIG. 11 shows the manner in which defined parameters are used to create a three-dimensional wireframe virtual model of the upper and lower shells in accordance with one embodiment of the present invention;

FIG. 12 is a screenshot of the three-dimensional wireframe virtual model of the upper and lower shells in accordance with one embodiment of the present invention;

FIG. 13 shows a milling machine unit in accordance with one embodiment of the present invention;

FIG. 14 shows a milling operation in which a shell is milled from a generic shell template in accordance with one embodiment of the invention;

FIG. 15 shows a heated moldable material being inserted into a channel of a shell in accordance with one embodiment of the present invention;

FIG. 16 shows the moldable material and shell of FIG. 15 being placed into engagement with a physical dental model in accordance with one embodiment of the present invention;

FIG. 17 shows a shell mold produced by a rapid prototyping machine according to one embodiment of the present invention;

FIG. 18 shows a shell having a mechanical locking mechanism in accordance with one embodiment of the present invention;

FIG. 19 shows the moldable material and shell of FIG. 15 being placed into engagement with a physical dental model using a lever and base unit in accordance with an embodiment of the present invention; and

FIG. 20 shows the moldable material and shell of FIG. 15 being placed into engagement directly with a patient's teeth in accordance with another embodiment of the present invention.

### DETAILED DESCRIPTION OF THE EXEMPLARY EMBODIMENTS

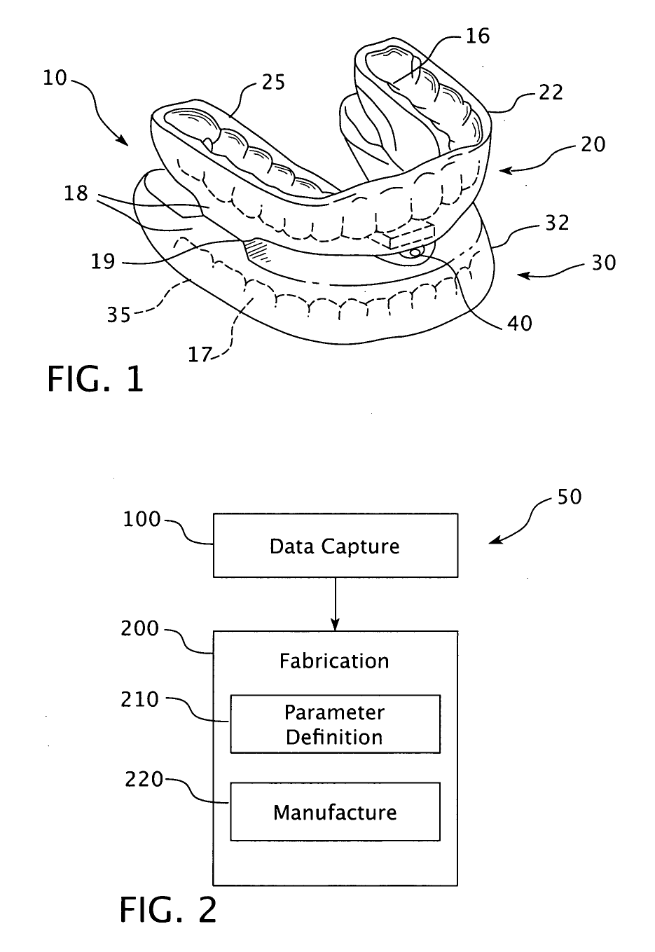

The present invention relates to a method of fabricating a mandibular advancement device 10, as shown in FIG. 1. The method utilizes electronic information to make production of advancement device 10 efficient and cost-effective. As shown, the mandibular advancement device 10 generally includes an upper bite block 20, a lower bite block 30, and a coupling device 40 for coupling bite blocks 20 and 30 in a manner described below.

Coupling device 40 aids in maintaining a patient's jaw in a remedial position by relatively positioning upper bite block 20 relative to lower bite block 30. Each of bite blocks 20 and 30 are precisely fitted to be retained by the respective dental arches of the patient. In an exemplary embodiment of the present invention and as illustrated herein, coupling device 40 is of Halstrom hinge type coupling device. This hinge is disclosed, in detail, in U.S. Pat. No. 6,161,542, the contents of which are hereby incorporated by reference in its entirety. The Halstrom hinge utilizes upper and lower retention elements that secure a stylus and guide box, respectively. The guide box includes a groove, with which the stylus engages, to permit a limited degree of lateral jaw movement. It should be appreciated that the present invention also contemplates a reverse configuration, wherein the stylus is secured by the lower retention element and the guide box is secured by the upper retention element, which would be equally effective.

However, the present invention contemplates that other suitable coupling devices that maintain the patient's lower jaw (mandible) in a protruded position relative to the upper jaw (maxilla) may be used. For example, it is contemplated that the coupling device may take the form disclosed in U.S. Pat. No. 5,427,117 to Thornton, the contents of which are also hereby incorporated by reference in its entirety. The Thornton device taught by the '117 patent discloses a coupling device in the form of a post extending from the upper bite block and engaging with the lower bite block to extend the patient's mandible forward.

As another example, the coupling device may take the form of that disclosed in U.S. Pat. No. 5,409,017, to Lowe, the contents of which are hereby incorporated by reference in its entirety. The Lowe device taught by the '017 patent describes a mandibular repositioning appliance that utilizes a coupling device that is connected to a rear portion of an upper bite block and a forward portion of a lower bite block. The coupling device allows some lateral movement of the jaw and comprises a double-threaded element to make adjustments to the degree of advancement of the lower jaw.

As another example, the coupling device may take the form disclosed in U.S. Pat. No. 6,604,527 to Palmisano, the contents of which are hereby incorporated by reference. The Palmisano device taught by the '527 patent, similarly to the devices previously mentioned, utilizes upper and lower bite blocks to position a patient's mandible in a protruded position. In this case, however, each of the bite blocks has a coupling device in the form of a flange extending therefrom near the posterior teeth. The flanges (or coupling devices) engage with each other to maintain the lower jaw in a position forward of the normal, habitual, position during sleep. In this arrangement, the coupling device is not located in the middle of the mouth, allowing the jaw to be opened and closed so that a patient may yawn, eat, drink, or close their lips. A device similar to that disclosed in the '527 patent is currently manufactured and sold by SomnoMed, Inc.

A further example of a coupling device that may be used is employed in a device currently sold under the trademark EMA™ by Frantz Design, Inc., and disclosed in U.S. Pat. No. 6,109,265 to Frantz et al., the contents of which are hereby incorporated by reference in its entirety. The Frantz device comprises an upper bite block and a lower bite block that are coupled by way of elastic bands. The elastic bands are biased in a direction to maintain the lower bite block in a protruded position, thereby attenuating obstructive sleep apnea and snoring.

The process presently disclosed therefore may be practiced with a wide variety of coupling devices 40, including, but not limited to, those mentioned above.

Bite blocks 20 and 30, in one embodiment, may be formed from more than one material. However, it is contemplated that only a single material may be used. When bi-material bite blocks are used, they may include a relatively harder outer shell and a relatively softer teeth engaging portion. Specifically, in one embodiment, as illustrated in FIG. 1, upper bite block 20 has an upper outer shell 22, and lower bite block 30 has a lower outer shell 32. Each shell may be fabricated to be generally shaped according to a respective one of the patient's dental arches. Upper shell 22 defines an upper inner channel 25, and lower shell 32 defines a lower inner channel 35 therein. Inner channels 25 and 35 are adapted to contain a second material that forms teeth engaging portions 16, 17 that more closely conform to a patient's teeth. Each of outer shells 22 and 32 of mandibular advancement device 10 may further be formed or shaped to include respective integral (or separately formed and then attached) bite pads 18 that form the regions of engagement between upper bite block 20 and lower bite block 30 at interface 19. In an exemplary embodiment, bite pads 18 protect the device from excessive biting pressure and facilitate proper jaw alignment. In one embodiment, outer shells 22 and 32 may be made of a hard acrylic or other suitable material to provide sufficient structural integrity to the mandibular advancement device 10. Other materials that may be used for shells 22, 32 include ceramic, resin, plastic, and metal, for example.

As shown in FIG. 2, a method 50 for forming the mandibular advancement device 10 generally comprises two steps: a data capture step 100 and a fabrication step 200. Fabrication step 200 may generally be broken down into two processes: parameter definition 210 and manufacture 220. Data capture step 100 obtains information detailing the shape and contours of a patient's dentition and feeds it digitally (“digitally” is used herein interchangeably with “electronically”) to a computer console or other electronic data processing and/or storage device. The computer console and associated software receives the captured electronic information detailing the dentition and, in conjunction with further inputs from either an operator or a separate software module defining parameters related to the particular dimensions for the bite blocks 20, 30, compiles the information to electronically form a three-dimensional wireframe virtual model for each of the upper and lower shells 22, 32.

The physical shells 22, 32 are then fabricated according to the data supplied by the computer software by either casting, milling, or other suitable method. Shells 22, 32 are then filled with the moldable material that forms the teeth engaging portions 16, 17, respectively. The moldable material is then applied to the patient's teeth and allowed to permanently set to form a precise fitting. Alternatively, the moldable material is applied to a cast or stone model of the patient's teeth and allowed to permanently set as described above. Coupling device 40 is secured to upper shell 22 and lower shell 32 and is set to maintain lower bite block 30 at a predetermined degree of protrusion so as to relieve the patient of problems related to obstructive sleep apnea and/or snoring. A detailed description of the process follows.

A. Data Capture

Data Capture step 100 produces electronic information or data that is related to the shape or contours of the patient's maxillary and mandibular dentitions. The electronic information is acquired as either a virtual model 166 of the patient's teeth, as shown in FIG. 7, or as a four-view data set of digital images 102, 104, 106, 108 of the patient's teeth, as shown in FIG. 5. The electronic information is stored in a computer console 214 (see FIG. 8) or other electronic data processing and/or storage device and is used to fabricate upper and lower shells 22 and 32 of mandibular advancement device 10.

The Data Capture step 100 may utilize either a traditional physical model 122 of a patient's teeth that is made using conventional model forming techniques, coupled with taking of digital photographs of the physical model, or, alternatively, utilizes a three-dimensional optical scan 166 of a patient's oral cavity. The former involves a process that most dental professionals are already familiar with. Specifically, dentists often make artificial stone, plastic, or plaster models of patients' teeth for other purposes, such as crown, bridge, denture, inlay, or overlay work, for example. The present invention contemplates that this methodology can also be employed to capture data in one embodiment. The latter involves a digital or analog imaging process for taking scanned images of the patient's teeth directly. The scanned images or digital photographs enable the dentist to keep electronic dental records for patients and also facilitate electronic transmission of the patient's dental information to the patient or third parties, such as a dental laboratory or a specialist. Keeping the dental information in an electronic database may also provide additional value to dental professionals and patients alike for future reference. The dental professional may, therefore, be enabled to utilize the original patient dentition data as a reference against a future acquisition of the patient dentition data. The dental professional can then determine appropriate action if any undesirable change in the patient's dentition is noticed over time.

As yet another alternative, the dental professional may take a three-dimensional scan of a formed physical model of the patient's teeth.

The particular method chosen by a dentist may depend on his or her comfort level with digital technology versus the more traditional method. Both approaches are contemplated by the present invention.

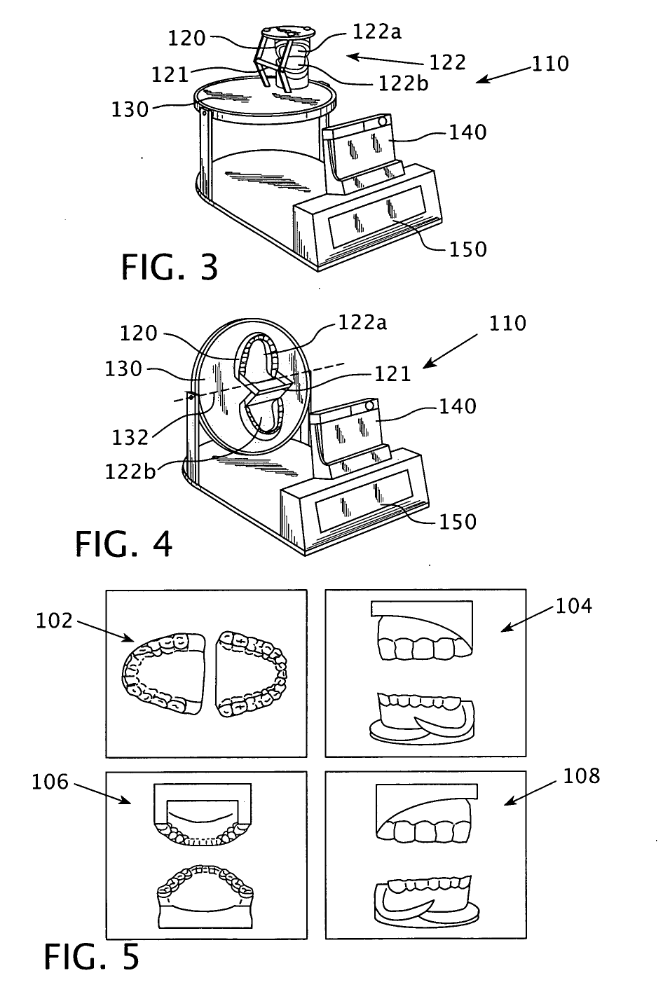

In accordance with the approach wherein a physical dental model 122 (see FIG. 3) is made, impressions are first taken of a patient's maxillary (upper) and mandibular (lower) dentitions with a moldable material. The materials used for direct impressions are typically mixed into a paste or “goop” and placed into a tray. Different compositions or materials may be used to form the direct impressions, such as agar, alginates, elastomers, impression plasters, zinc oxide eugenol, impression waxes, or other similar material. The tray is placed over the patient's teeth and the material has such properties as to allow it to set after some time to record the impression. Artificial dental stone, plastic, or plaster may then be poured into the impression and cast so as to form an accurate model of the patient's upper dentition 122a and lower dentition 122b (see FIG. 4).

Once physical model 122 is formed, digital photographs are taken of the model in order to record the information in electronic form. For this purpose, a Data Capture Unit 110 may be used, as shown in FIG. 3. The Data Capture Unit 110 may comprise a turntable 130, an articulator 120, a digital camera 140, and a control panel 150. The Data Capture Unit 110 may photograph physical model 122 of the upper and lower jaw in four orientations 102, 104, 106, 108, as shown in FIG. 5, in order to acquire the necessary information in the fabrication of the mandibular advancement device 10. Fewer or more orientations may be recorded, depending on the data requirements of the software, discussed below.

Turntable 130 may be generally circular and capable of rotating in its horizontal plane (i.e., about an axis orthogonal to a plane defined by its surface and passing through its substantial center point) as well as pivoting about an axis through its diameter 132 to a position such as that shown in FIG. 4. The motion of turntable 130 may be automatically controlled by control panel 150 located on Data Capture Unit 110 or by commands transmitted by a connected computer console (not shown), or the turntable may be rotated manually.

As shown in FIGS. 3 and 4, an articulator 120 may be used to secure physical dental model 122 onto the turntable 130 and to position the model in the desired arrangement. A traditional bite registration is taken from the patient using a pressure plate or similar device to determine the natural relative positions of the maxillary and mandibular dentitions and the patient's arch profile. The bite registration is then used to align dental model 122 in articulator 120 in the correct, natural, position. The articulator may then be elongated vertically, while maintaining the proper alignment, in order to widen the gap between upper portion 122a and lower portion 122b of model 122. The gap between the portions of model 122 aid the dental professional in performing subsequent steps in the manufacturing process by eliminating overlap of the portions of the dental model while retaining their critical spatial relationships. Dental model 122 may be clamped or otherwise firmly secured to the articulator 120. The articulator 120 is securely attached to the turntable 130 by any suitable mechanism, such as bolts or clamps. Articulator 120 may further include a hinge 121 so that it may be positioned in either a closed configuration as shown in FIG. 3 or an open configuration as shown in FIG. 4.

A digital camera 140 may be placed a short distance away from turntable 130 and used to capture images of physical dental model 122. Digital camera 140 may be mounted on a platform that is on the same horizontal plane as the surface of turntable 130 so as to obtain level images. The camera may be controlled by control panel 150 located on the Data Capture Unit 110, by commands transmitted by a connected computer console, or manually. Digital camera 140 may be provided with features including an optical view finder, USB connectivity, LCD display, tripod socket, PC/web camera mode, or short focus range (e.g., 10 cm).

In the next step, three horizontal views are acquired. Specifically, to acquire side views 104, 108 and rear view 106 of dental model 122, articulator 120 may be positioned in the closed configuration and turntable 130 may be placed in a horizontal position, as shown in FIG. 3. Turntable 130 may then be successively rotated in order to capture the three horizontal orientations 104, 106, 108 by taking photographs with the digital camera 140. A fourth, top view 102, is then acquired. To acquire a top view 102 of dental model 122, turntable 130 may be pivoted vertically and articulator 120 may be pivoted about hinge 121 and placed in an open configuration, as shown in FIG. 4. The electronic information captured by the digital camera 140 may then be transmitted via a connecting cable (or wirelessly) to computer console 214, shown in FIG. 8, or other data processing and/or storage device.

As an alternative to taking digital photographs of the physical model, the present invention also contemplates that physical dental model 122 or just the dental impressions may be optically scanned by a three-dimensional optical scanning device. Accordingly, the imaging process may involve the use of a laser to scan a stone model or impression from several perspectives and stitch the overlapping views together to produce a three-dimensional virtual dental model, for example, see emodels™ available from Geodigm Corporation. Scanning of the physical dental model can also be performed by a process known as destructive scanning. Destructive scanning approaches involve removal of a thin layer of the impression and/or stone by sanding or slicing. Sectional images are acquired between removal of layers to produce a stack of images that are used to reconstruct the three-dimensional model of the dentition.

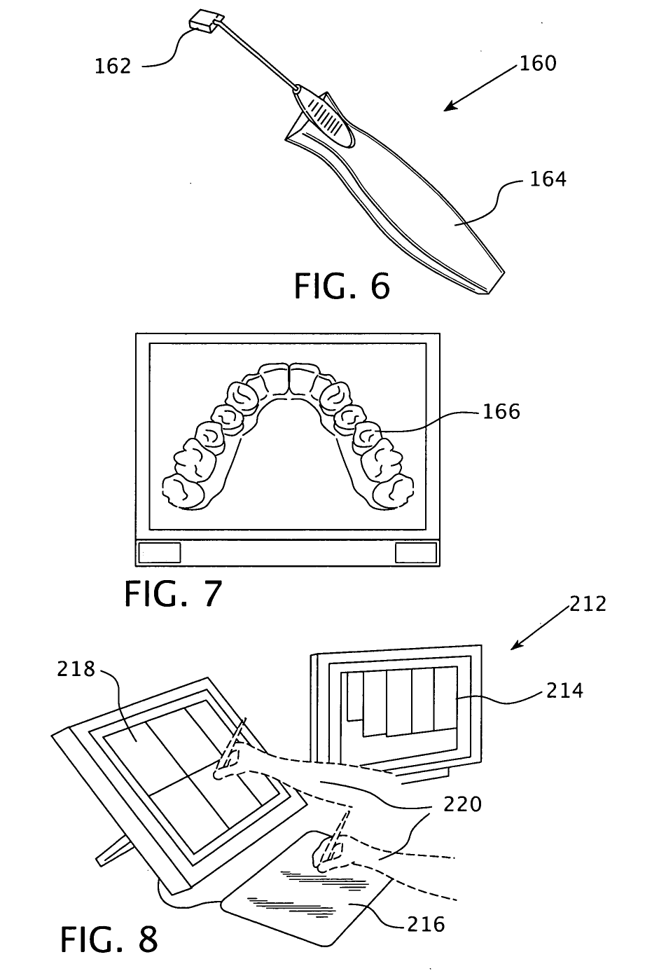

As mentioned previously, as an alternative to acquiring electronic information by taking digital photographs (or scans) of physical dental model 122, a dentist may choose to perform a direct optical scan of a patient's oral cavity using an optical impression system 160 and three-dimensional imaging. See FIG. 6. An optical impression system is a device used to record the topographical characteristics of teeth, dental impressions, or stone models by analog or digital methods for use in the computer aided design and manufacturing of dental devices. Such systems may include a camera, optical scanner, or equivalent type of sensor and a computer with software. An optical scan in accordance with the present invention can be carried out by laser scanning, white light intra-oral scanning, digital x-ray, reflective powder, high-resolution intra-oral camera, or other suitable scanning device.

An example of a suitable optical impression system is a device known as OraScanner™ from OraMetrix, Inc, shown in FIG. 6. This scanning device 160 is a handheld apparatus that includes a sensor portion 162 and a handle portion 164 for manipulation. Scanning device 160 projects a defined pattern onto the dental crowns and its distortion is recorded by a small video camera 162. The stamp-sized images are streamed to a computer, processed, and stitched together to create a complete dental arch. A dental arch can be imaged in approximately one minute. Factors such as tooth crowding and the size of the mouth affect the length of time that a scan takes. The OraScanner™ device, for example, is accurate to fifty microns and is based on white light technology, which is non-invasive and can be used repeatedly on patients with no adverse effects. Scanning device 160 uses active triangulation that allows for precise three-dimensional scans without the need for a fixed point of reference. A further sensor that is adapted for intra-oral scanning is disclosed in U.S. Pat. No. 6,169,781, the contents of which are hereby incorporated by reference in its entirety.

Alternatively, the three-dimensional scanning device may be an external scanning system that scans the patient's teeth from the exterior of the patient's mouth. Such a device may be an x-ray apparatus, such as that disclosed in U.S. Pat. No. 6,049,584, the contents of which are hereby incorporated by reference in its entirety. Other external scanning systems suitable for use in the present invention include a CAT Scan (CT Scan) or MRI. An externally scanning apparatus has the advantage of minimizing the obtrusiveness and possible discomfort to the patient.

In the case of directly scanning a patient's oral cavity, the data acquisition process would be streamlined in part by eliminating the step of creating a physical model 122 of the dentition. A digital bite registration and arch profile is scanned from the patient with an electronic pressure plate. Associated software uses this information to properly align the three-dimensional CAD (computer aided design) virtual model 166 (see FIG. 7) of the patient's dentition, as opposed to alignment by placing physical model 122 onto articulator 120, as may be done in the previously described data capture process. Electronic pressure plates suitable for this purpose are currently available from Tekscan, Inc. Any suitable CAD application may be used to manipulate and display the three-dimensional virtual model 166, such as OrthoCAD™, available from Cadent, Inc., Rapidform™, available from INUS Technology, Inc., or FreeForm™, available from SensAble Technologies, Inc.

In all forms of data capture, the resulting product of this step may comprise electronic information or data that is related to the shape or contours of the patient's maxillary and mandibular dentitions. Specifically, the data acquired may take the form of three-dimensional virtual stone model 166 of the dentition, as shown in FIG. 7, or the four-view data set acquired by digitally photographing a physical model, as in FIG. 5. The three-dimensional image acquired by intra-oral scan or physical model scan, shown in FIG. 7, or four-view data set as in FIG. 5, is stored in a computer console 214 or other electronic data processing and/or storage device and is the starting point of the next step in the process.

B. Parameter Definition

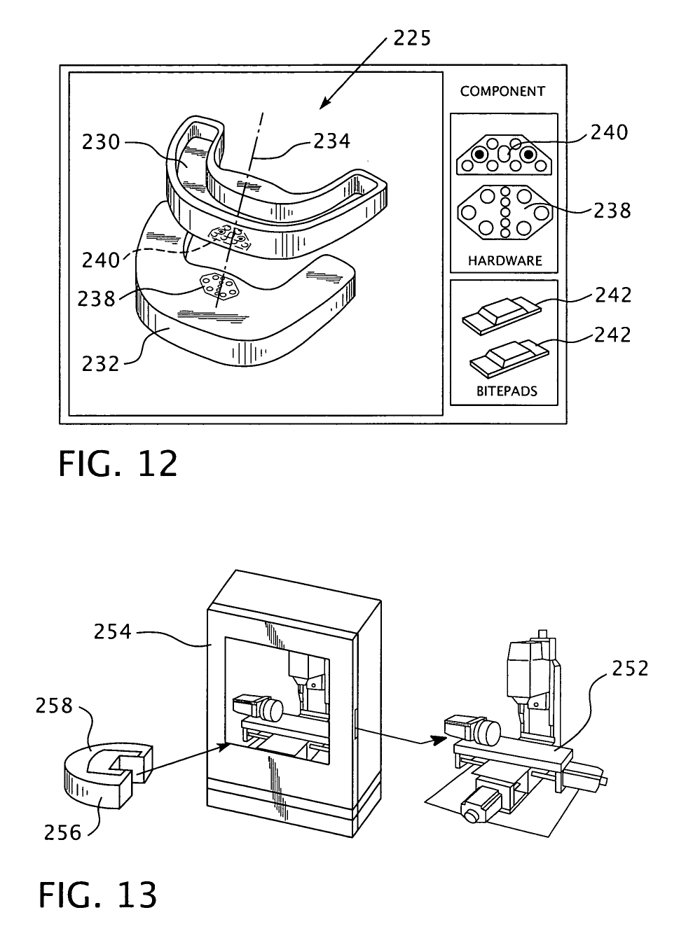

In parameter definition step 210, the electronic information obtained from data capture step 100 is transformed into information that can be used to construct mandibular advancement device 10. This step may be performed manually by a dental professional or automatically by a computer program. The resulting product of this step may comprise a software-rendered three-dimensional wireframe virtual model 225 (see FIG. 12) of physical shells 22, 32 that eventually make up a part of the final mandibular advancement device 10.

As shown in FIG. 12, wireframe virtual model 225 includes an upper shell model 230 and a lower shell model 232. In rendering electronic models 230, 232 of shells 22, 32, respectively, the software receives inputs regarding necessary minimum dimensions, as well as information regarding the locations of the placement of coupling device 40, and then compiles the information to yield wireframe virtual shell model 225, as shown in FIG. 12. The inputs may be supplied by an operator or by a computer program designed to compute and recommend parameters. The rendered wireframe virtual shell model 225 is complete with placement of the coupling device retention elements 238, 240 and bite pads 242, as shown in FIG. 12, which is a display showing a schematic of the incorporated components (retention elements 238, 240 and bite pads 242) alongside the rendered three-dimensional wireframe virtual shell model 225. The software may be adapted to allow for operator adjustment of the placement of the retention elements 238, 240 and bite pads 242.

The software may also be adapted to receive an input corresponding to a specified wall thickness for shells 22, 32. The dental professional makes a determination for the optimum thickness by balancing the respective comfort to patient and strength of material considerations. The software may be programmed with a default wall thickness such as, for example, two millimeters, or may be provided with an algorithm that automatically determines an optimum shell wall thickness based on other parameters, e.g., size of patient's mouth, shape of dental arches, etc. To further contribute to the patient's comfort, the outer contour of the shells may be formed to closely correspond to the outer surface contours of the teeth so as to reduce or minimize space in the patient's mouth occupied by the device. Alternatively, the outer contour of the device may have a smoother, rounded configuration.

Manual parameter definition may be performed by using a module 212, as shown in FIG. 8, that includes a computer 214, a software package installed on the computer, and a drawing tablet 216 with a screen 218 configured to register and display inputs made by manual sketches with a stylus 220 on the tablet 216 and to feed the inputs to the computer 214. Alternatively, screen 218 may be a touch-screen or some other pressure-sensitive display screen, which would obviate the need for a separate drawing tablet 216.

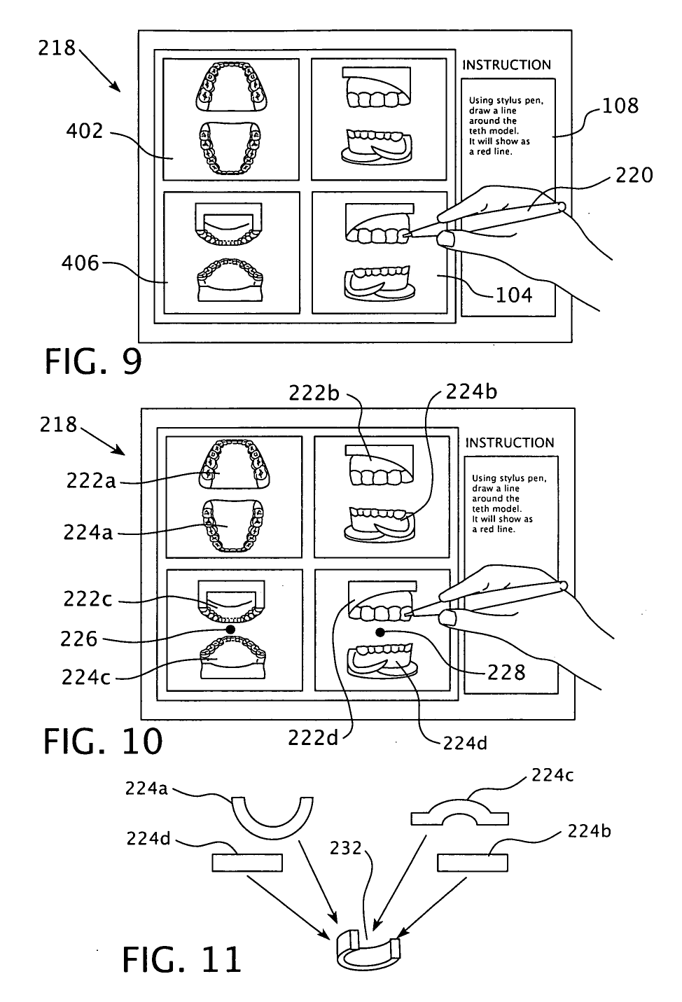

The software package receives the electronic information from the data capture step and displays the images on screen 218, as seen in FIG. 9. The images displayed may correspond to right side 104, left side 108, rear view 106, and top view 102 of the virtual model of the patient's teeth, or any other views that may be required by the software. A dentist or other dental professional then uses stylus 220 on the touch-screen, pressure sensitive screen, or drawing tablet 216 to draw around the images of the teeth in each view, as shown in FIG. 10, so as to generally define the shape of the area that the mandibular advancement device 10 should occupy. The computer software records the shapes formed 222a-d, 224a-d by the outlining of these regions.

After drawing outlines 222a-d, 224a-d around the teeth that are to be surrounded by mandibular advancement device 10, the dental professional may then indicate with stylus 220 a pair of points 226, 228 that indicate the horizontal position at which coupling device 40 is placed (the vertical location is not relevant for this purpose), as shown in FIG. 10. Only two points need be identified, one in each of two orthogonal horizontal views (two of 104, 106, or 108). By identifying the horizontal location of coupling device 40 in two orthogonal horizontal views, the software has enough information to determine an axis 234 of operation (see FIG. 12) along which coupling device 40 acts. It can be appreciated that only the horizontal placement of points 226 and 228 is critical, because the end result of this particular step is the determination of a vertical axis of operation 234, obviating the need for vertical positioning. The placement of coupling device 40 is a case-specific determination that depends upon the unique characteristics of each patient and is within the knowledge and skills base of a trained professional. In another embodiment, it is contemplated that software provided with module 212 may determine an ideal placement for each retention element 238, 240.

Further, as the present invention may be used with a great variety of coupling devices, different types of coupling devices may be required to be attached to bite blocks 20, 30 in different locations and by different methods, as will be appreciated from the patents previously incorporated by reference herein. Whatever the required location may be for the particular coupling device used, a dental professional may input the location into the computer, or choose some other point of reference (as discussed below), to achieve the desired result.

Thus, in accordance with the present method the operator inputs the parameters comprising shapes 222a-d and 224a-d, shown in extracted form in FIG. 11, and the horizontal positions of coupling device 40 in two of horizontal views 104, 106, or 108. Shapes 222a-d, 224a-d that correspond to the patient's arches, which are accommodated by the shells 22, 32, and the placement of coupling device 40 allows the software to identify an axis 234, as shown in FIG. 12, along which the coupling device will operate. Axis 234 is used in the manufacturing process as a point of reference. Thus, as is described in greater detail below, stock material out of which the shells are to be manufactured may have pre-installed coupling device retention elements 238, 240 so that the manufacturing device can provide an output that is properly aligned according to the virtual shell models 230, 232.

If retention elements 238, 240 are not pre-installed in the stock material, or if a coupling device 40 other than a Halstrom hinge is used, alignment may still be effectuated by identifying a point of reference by supplying inputs, in relation to the digital images, to the software that correspond to designated points on the stock material. For example, an operator may find it expedient to use a reference point that does not depend on the placement of a particular coupling device 40. In such a case, the operator may choose to simply use the middle of the patient's dentition, for example, as the point of reference. The operator thus marks the points corresponding to the middle of the dentition with stylus 220, which would result in a display that is indistinguishable from the previous result as shown in FIG. 10. The manufacturing device is accordingly programmed to set the middle of the stock material as the reference point and the process may therefore be carried out in the absence of any specific coupling device. An operator may alternatively wish to use a certain tooth or any other location as the point of reference.

In another embodiment, a computer program may be utilized instead of operator module 212 to supply the necessary parameters to the compiling software. Using the electronic information acquired from Data Capture step 100, the program may be designed to recognize the supplied images and recommend trim lines, profiles, and/or coupling device placement. An operator may be given the option to accept the recommendations or to modify them.

The result of Parameter Definition step 210 is a three-dimensional electronic wireframe model 225 of upper shell member 230 and lower shell member 232 of mandibular advancement device 10, as depicted in FIG. 12. This information is then used in the next step to manufacture physical shells 22, 32.

C. Manufacture

Several methods may be used in this step to manufacture upper shell 22 and lower shell 32. Each of the methods may comprise a manufacturing device or set of devices that receives electronic data relating to the shell specifications and subsequently carries out the manufacturing function, or a part thereof, automatically.

One possibility for producing physical shells 22, 32 is to utilize a milling machine 252, as shown in FIG. 13. The present invention contemplates that milling machine 252 is a three-axis computer numerical control (CNC) milling machine and may be supplied the specifications of wireframe shells 230, 232 from the computer console to automatically mill the specified dimensions into a supplied material. One such device is the DMS-M105 CNC Mini-Mill/1 (hereinafter referred to as “Mini-Mill”), manufactured by Minitech. The Mini-Mill is a metal milling machine having a footprint of 1.5 feet by 1 foot. It includes a sound-proof casing so that there is no disturbance to the rest of the dental office and has a digital display that reads the status of the part being machined and may notify the user when the part is finished. It may also be possible to use a milling machine designed solely for plastic milling. A plastic milling machine would have lesser capabilities but may carry with it reduced costs.

The supplied material may be a generic shell template 256 that is universally sized in order to accommodate whatever possible dimensions a patient may require for their particular shell. The present invention also contemplates providing a supply of differently sized generic shell templates 256. An appropriately sized template 256 may be chosen based on the patient's needs so as to reduce the amount of work that must be performed by milling machine 252. The material used to make the generic shell templates may be a hard acrylic, typically used for dental purposes, or may be another suitable material such as ceramic, resin, metal, plastic, etc. Another suitable material may be the product currently sold under the trademark Rebound™ (polycaptone) by Chesapeake Medical Products, Inc. Generic shell templates 256 may be formed by injection molding, casting, or other suitable method. The milling machine may be provided with a case 254 that may comprise a material that acts as a sound barrier so as to reduce the noise emanating from the milling machine. Case 254 may also protect milling machine 252 from external forces or lend to maintaining appropriate aesthetics.

To aid in properly aligning generic shell template 256 on milling machine 252, retention elements 238, 240 of coupling device 40 may be embedded 258, bonded, screwed, or otherwise secured to the generic template prior to the milling procedure. Doing so may provide a point of reference for the milling machine that corresponds with previously supplied information to the software. Milling machine 252 may then use the location of retention elements 238, 240 of coupling device 40, as indicated by the supplied electronic data to be properly aligned with physical material 256, to produce an accurate result.

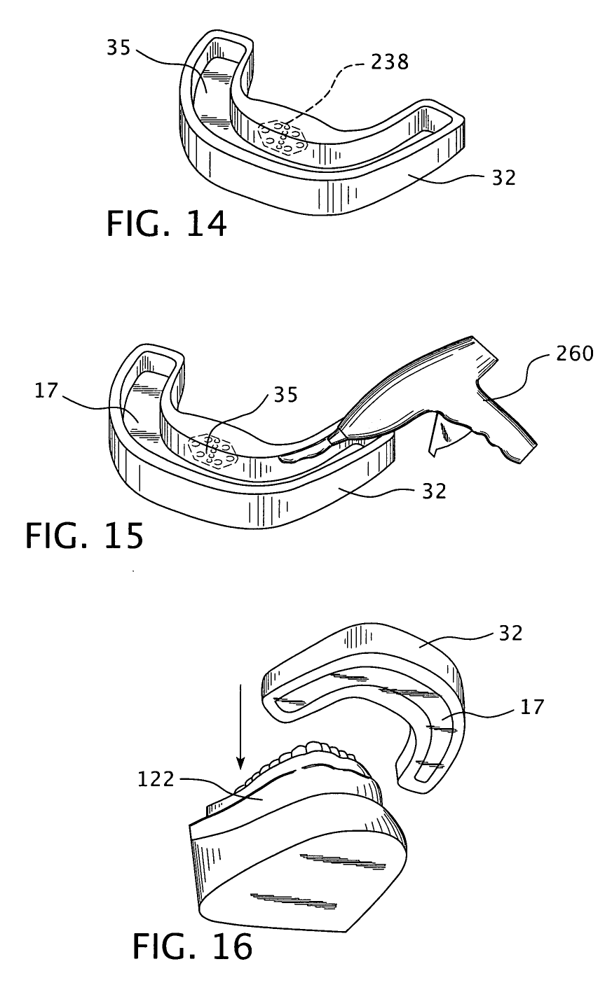

Milling machine 252 may therefore output upper and hard acrylic shells 22, 32 with retention elements 238, 240 of coupling device 40 in place and custom shaped to accommodate the specific patient's dentition. Upper and lower shells 22 and 32 may be formed so as to have upper and lower channels 25 and 25 defining the general outline of the patient's dental arches, as shown in FIG. 14, which depicts a lower shell 32 after being shaped by milling machine 252 according to the supplied electronic data. The software may be configured to provide a predetermined thickness of channel 35 in relation to a patient's tooth thickness. The predetermined thickness provides a clearance that allows the insertion of a second material 17 that may be precisely molded to the contours of a patient's dentition, as described below.

Alternatively, retention elements 238, 240 may be secured to shells 22, 32 after being milled. In this case, another alignment mechanism may be used to align generic template 256 on milling machine 252, such as simply marking the future location of retention elements 238, 240 and matching it to the data or by employing some other alignment scheme, such as the process described above with respect to Parameter Definition step 210.

Thus, retention elements 238, 240, or any other required hardware for the particular coupling device being used, may be fastened by screws, bolts, adhesive, epoxy, welding, or any other suitable fastening mechanism either before or after the milling process. Moreover, the coupling device elements may be formed out of generic shell template 256 during the milling process, if the particular coupling device being utilized so allows, such as may be the case for the coupling device disclosed by Palmisano in U.S. Pat. No. 6,604,527, as described and incorporated herein above.

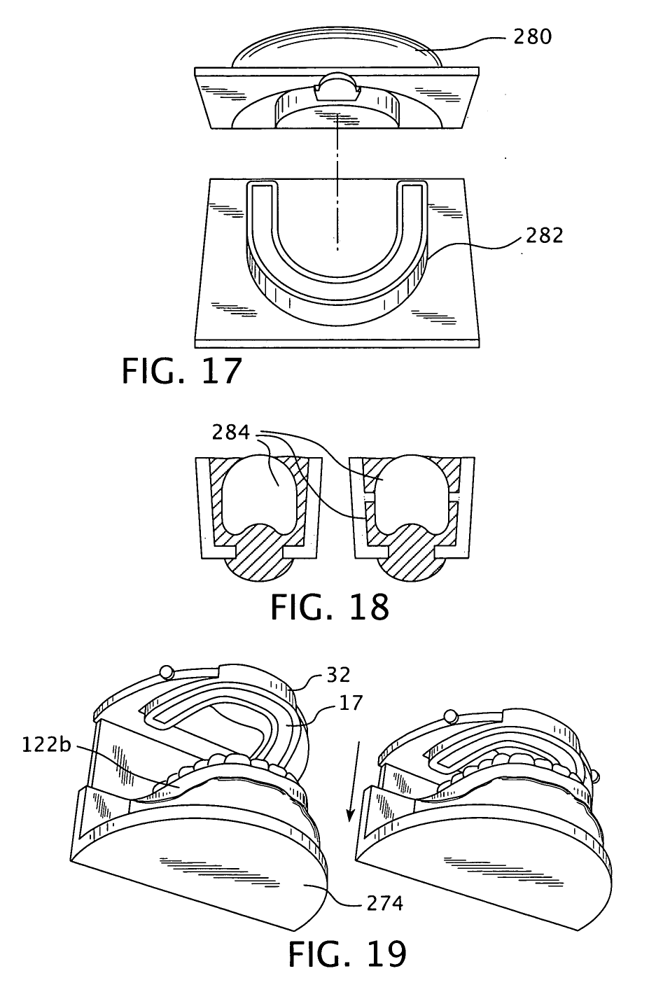

Custom upper and lower shells 22, 32 according to the specifications of three-dimensional wireframes 230, 232 can alternatively be manufactured by a casting or by an injection mold method. In this manner, molds 280 and 282 are produced according to the negative of wireframe shell models 230, 232, as shown in FIG. 17. Molds 280 and 282 are the two mold halves that are joined together and the gap defined between the two is filled or injected with a hard acrylic polymer, or other suitable material, to form the upper shell and/or the lower shell. The present invention contemplates that in a typical situation, different molds will be needed for the upper and lower shells, but for the sake of the present application, only one mold pair is shown and discussed herein. Molds 280 and 282 may be produced by a rapid prototyping device, employing such technology as stereolithography, selective laser sintering, fused deposition modeling, or other rapid prototyping technology known in the art. Retention elements 238, 240 of coupling device 40 may be placed into molds 280 and 282 prior to pouring or injection so that they become embedded or bonded with upper and lower shells 22, 32 upon formation.

Rapid prototyping is a suitable manufacturing process for the present purpose because each part is inexpensive to build and can easily withstand single-time injection, as required by the method in accordance with the present invention. Rapid prototyping allows one to create a solid model directly from computer data and to realize immediate physical representation of designs. Rapid prototyping also enables more complex geometries than conventional methods, such as CNC machining. The basic operation of rapid prototyping is as follows: a three-dimensional computer design is “sliced” into a series of thin cross-sections; the cross-sections are translated into two-dimensional coordinates; and this data is used to control placement of the “build” material, which is repeated for each cross-section and the object is built from the bottom up, one layer at a time.

Stereolithography (SLA) is currently the widest used rapid prototyping system. During the SLA process, UV light is directed from a computer-controlled laser onto the surface of a vat of photosensitive liquid resin. Upon light striking the surface, the photopolymer solidifies. As each layer is completed, the part is successively lowered into the vat, a thin layer of new liquid spreads over the surface and the process is repeated. Suitable materials for use in an SLA rapid prototyping process include ProtoTool™, available from DSM, Inc., and BlueStone™, available from 3D Systems, Inc. Both of these products are filled resins having sufficient strength properties for the present purposes.

Selective Laser Sintering (SLS) builds objects from a bed of fine powder of plastic or plastic-coated metal or ceramic particles that is sintered by a traveling laser beam. SLS is currently the second most popular rapid prototyping system.

In fused deposition modeling (FDM), a hot-glue gun is mounted on an x-y plotter mechanism and extrudes a thermoplastic material such as ABS plastic (acrylonitrile-butadiene-styrene). A filament of material is fed into an extrusion head and heated to a semi-liquid state. Each layer is formed by the head extruding a thin bead of plastic that solidifies as soon as it has been extruded.

Other systems may involve using the ink-jet principle to deposit droplets of materials in successive layers, such as molten thermoplastic, or other newly developing procedures. Any of the preceding rapid prototyping systems may be used in accordance with the present invention, each providing different benefits, to produce molds 280, 282 used for casting upper shell 22, lower shell 32, or both. Hard acrylic may then be injected into the molds or otherwise cast to form shells 22, 32.

Injection molding is a high pressure manufacturing procedure where material is injected into a mold. Several tons of pressure may be used to force material into a cavity. Making a small part, such as shells 22, 32 relieves some of the pressure requirements required to inject material into the mold. A metal jig may be placed around rapid prototyped molds 280 and 282, if necessary, in order to increase their rigidity, making their one-time use viable. A stock “o-ring” may be used around the parting line of one of the mold halves to help reduce excess plastic material (flash) that escapes through the mold.

Once upper shell 22 and lower shell 32 are formed, whether by milling a generic template 256, casting with molds 280 and 282, or any other process, they may be filled with a moldable material 16, 17, placed onto a patient's teeth or onto physical model 122, and allowed to set. With reference to the depiction of lower bite block 30 and its related elements in FIGS. 15 and 16, moldable material 17 may preferably bond or otherwise attach to the walls of channel 35 in shell 32 and may produce an inner formation in bite block 30 that is precisely contoured to the patient's dentition. The same process may be carried out with upper bite block 20 and its related elements. Suitable materials for this purpose may include ethylene vinyl acetate (such as the product currently sold under the trademark “Elvax™”), moldable thermoplastics (such as the product currently sold under the trademark “Thermacryl™”), rubber molding compounds (such as the product currently sold under the trademark “Silicone Plastique™”), or other suitable materials.

The product currently sold under the trademark Elvax™ by E. I. du Pont de Nemours and Company is a soft acrylic material that may be produced in the form of solid strips or pellets. A dispensing gun 260, known as the Elvaxor 300™ may be used to heat Elvax™ strips and dispense it into channels 25, 35 of shells 22, 32 in a semi-solid state. The Elvaxor 300™ has an insulated, easy to grip handle and a temperature indicator to let the user know when the material is soft enough to dispense. Elvax™ is pliable and re-shapeable, which gives the dental professional complete control over device 10, and is easily trimmed for comfort.

The product currently used under the trademark Thermacryl™ by Airway Management, Inc., may alternatively be used as the moldable material 16, 17. Thermacryl™ is another soft acrylic produced in pellet form or strips, and turns clear and softens considerably when heated to 160°. The heating can be done in a microwave for one or two minutes, or the material can be placed in hot water. Thermacryl™ may be reheated and reshaped as needed over time.

The product currently sold under the trademark Silicone Plastique™ by Culinart, Inc., is an FDA-approved two-part rubber RTV (room-temperature vulcanizing) molding compound and may alternatively be used as moldable material 16, 17 to fill channels 25, 35 of shells 22, 32. Silicone Plastique™ may provide a non-toxic molding compound that a dental professional may prepare in a similar manner to the taking of traditional dental impressions.

While an RTV rubber may have superior durability characteristics, it may not be able to secure a lasting adhesive bond with the harder material of shells 22, 32. To remedy this potential problem, small undercuts or protrusions 284, as can be seen in FIG. 18, may be molded into the surface of the shells 22, 32 to allow the RTV rubber to mechanically lock, in addition to or instead of chemically bond. This remedy may be practiced with any material for which it is suspected that the chemical or adhesive bond between the outer shells 22, 32 and the inner moldable material 16, 17 may not last as long as desired. The remedy may also be used as an added layer of security for materials that do provide a sufficient chemical or adhesive bond.

In the case of setting inner moldable material 17 by placement upon a physical dental model 122b, a lever and clamp device 274, such as that shown in FIG. 19, may be used to ensure a uniform and secure hold against model 122b. A coating powder may be used to cover physical model 122, so that moldable material 16, 17 does not stick to it during fitting. Shell 32 is placed onto model 122b until moldable material 17 hardens, and the shell is then removed from the model.

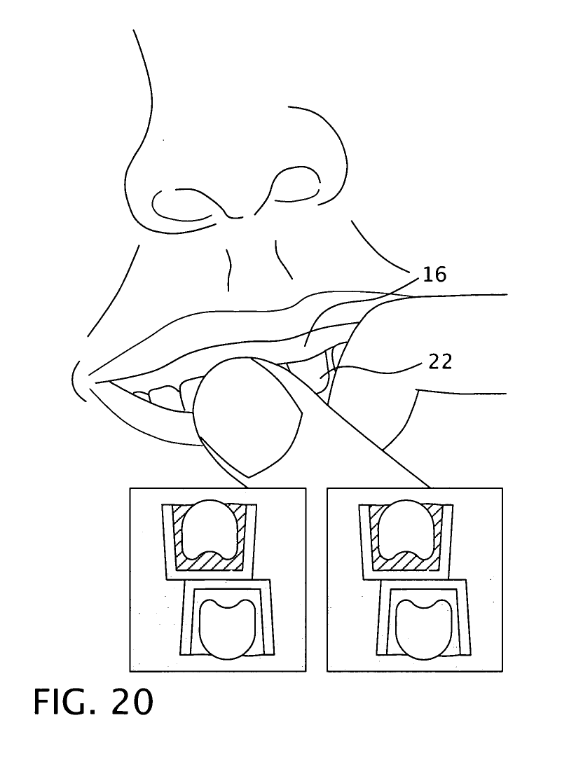

In the case of setting inner moldable material 17 by placement directly into a patient's mouth, the process is performed similarly to that of taking traditional dental impressions and is shown in FIG. 20. The dental professional may simply align and fit hell 22 with inner moldable material 16 in channel 25 into the patient's mouth and allow it to harden. Shell 22 and material 16 are then removed and the process is repeated with second shell 32 and material 17.

After inner moldable material 16, 17 is hardened and removed, a dental professional may then trim excess material, fit to the patient, and make any other necessary modifications for comfort, fixture, or otherwise.

With retention elements 238, 240 of the coupling device 40 already in place on upper shell 22 and lower shell 32, any other necessary hardware is installed, such as the guidebox and stylus as disclosed in the Halstrom patent (or the post disclosed in the Thornton device), and the two shells are coupled together, thus creating the finished mandibular advancement device 10. In use, the dental professional may determine an appropriate degree of advancement of a patient's mandible and adjust coupling device 40 accordingly. The patient may use mandibular advancement device 10 by securing bite blocks 20, 30 to his or her teeth during sleep. The protruded or position controlled mandible opens the pharyngeal airway and reduces occurrences and/or intensity of obstructive sleep apnea and snoring, thus improving the health of the patient.

The following examples are illustrative of the method according to the present disclosure. They represent only exemplary approaches and are not to be construed as limiting.

### EXAMPLE 1

The entirety of the method for producing a mandibular advancement device 10 may optionally take place within a dental office. Carrying out process 50 in this way results in a relatively fast turnaround time for the device and also gives the dentist an opportunity to add to his or her menu of services. The following procedure is not meant to limit the type of processes that may occur within the dental office and are only exemplary. For example, while this procedure describes the step of creating a physical dental model in the data capture step, a dentist may instead perform a three-dimensional optical scan of the patient's mouth in order to acquire the electronic information. All alternatives for each of the other steps likewise remain open for a dental office-specific procedure.

In the first step of process 50 of producing a mandibular advancement device 10, Data Capture 100, a dentist or other dental professional may create a physical model 122 of a patient's dentition as described above. Model 122 may be made of artificial stone, plastic, plaster, or other suitable material.

Physical model 122 may then be attached to articulator 120 and secured to turntable 130 as shown in FIG. 3, located in the dental office. In this position, two side views 104, 108 and a rear view 106 may be recorded by digital camera 140 and stored in a removable data storage device or directly to an attached computer 214. Articulator 120 is then rotated about hinge 121 to its open configuration, and turntable 130 is pivoted to its vertical position, as shown in FIG. 4, and the top view 102 is recorded by digital camera 140. Top view 102 and horizontal views 104, 106, 108 previously recorded are transmitted to a computer 214, which may be the customary dental office computer used for routine everyday tasks in the office, except that it has installed thereon the software necessary to carry out the process and may include the additional piece of hardware that is drawing tablet 216 and/or display screen 218.

The software is then run and the dental professional carries out the Parameter Definition step 210, as described above and in FIG. 10, by outlining 222a-d, 224a-d the regions around the teeth that must be accommodated by the mandibular advancement device 10. The dental professional then identifies the placement of retention elements 238, 240 of the coupling device 40.

The software compiles the provided information and produces a three-dimensional wireframe model of upper shell 230 and lower shell 232 of the mandibular advancement device 10 and corresponding locations of retention elements 238, 240 of coupling device 40, as seen in FIG. 12. This information is then transmitted to an attached milling machine 252, shown in FIG. 13, which then carries out an automated process that mills the desired shell shapes 22, 32 out of supplied generic shell templates 256, as described above and in FIG. 14.

Upper 22 and lower 32 shells may then be filled with a moldable material 16, 17, such as ethylene vinyl acetate (Elvax™), and placed over stone model 122, as shown in FIGS. 15 and 16. Moldable material 16, 17 is allowed to set, is removed, and any excess material is trimmed. Each shell 22, 32 is then fit to the patient to make any last modifications and/or trimmings.

Coupling device 40 may then be secured to its retention elements 238, 240, already attached to shells 22, 32, to finish the mandibular advancement device 10. Coupling device 40 may then be adjusted to provide an appropriate degree of mandibular advancement and device 10 is then ready to use.

Thus, a procedure has been laid out which may be carried out entirely within the dental office during a single patient visit. This procedure greatly improves efficiency and cost in the manufacture of mandibular advancement devices.

### EXAMPLE 2

In a second example, a procedure for manufacturing a mandibular advancement device 10 is laid out in which part of the process is carried out in a dental office and part is carried out at the location of a third party, such as a dental laboratory. This process again improves efficiency and cost and may be used in cases where a dental office prefers to outsource some of the major fabrication burdens due to capital costs, personal choice, or a different anticipated direction of business.

The step of Data Capture 100 may be performed at the dental office by three-dimensionally scanning a patient's mouth 166, as described above and in FIGS. 6 and 7. This step may alternatively be done by making a traditional physical dental model 122 and photographing it with a digital camera 140. The optical scan produces a three-dimensional virtual model of the patient's teeth 166, as shown in FIG. 7, which can then be sent by electronic mail or other electronic data transmission method to a third party (at the same or different facility), such as a dental laboratory.

Upon receiving virtual model 166 of the patient's dentition, the dental laboratory may perform the Parameter Definition step 210 manually or it may utilize software designed to recommend the necessary parameters, as discussed above. A computer program for this purpose may be configured to perform image recognition in order to recommend the necessary inputs, such as retention element placement, trim lines, and profiles. An operator may accept or modify the recommendations. Once the parameters are defined, the software compiles the information and produces an electronic wireframe model 225 of the upper 230 and lower 232 shells.

Because a dental laboratory is often in a position to utilize more sophisticated technology than is a dental office, the lab may use a rapid prototyping machine to “print” full-scale molds 280, 282 for the shells, as shown in FIG. 17. A hard acrylic or other suitable material may then be poured or injected into the rapid prototyped molds 280, 282 to cast or form upper 22 and lower 32 shells for mandibular advancement device 10. Shells 22, 32 may then be transmitted by mail (e.g., post or courier) to the dental office, along with a kit including the remaining materials, if necessary.

The remaining steps of the procedure may be performed in the dental office. A moldable material 16, 17, such as a thermoplastic (e.g., Thermacryl™), may be inserted into shell channels 25, 35 and then placed into the patient's mouth to fit over the teeth, as is described above and shown in FIG. 20. Moldable material 16, 17 may then be allowed to set and is then removed and trimmed. Each shell 22, 32 may then be fit to the patient to make any last modifications and/or trimmings.

Coupling device 40 may then be secured to its retention elements 238, 240, which have already been attached to shells 22, 32 during the injection molding or casting process, to finish the mandibular advancement device 10. The coupling device may then be adjusted to provide an appropriate degree of mandibular advancement and the device 10 is then ready to use.

Thus, a procedure has been described that likewise improves efficiency and costs, and reduces the burden that is placed upon the dental office in the first example. Particular circumstances may tend to favor certain options; the process herein described is contemplated to be a general progression of tasks that encompasses any combination of described specific options, as well as those recognizable as equivalent to those having skill in the art.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A method of forming a mandibular advancement device comprising:
acquiring electronic information relating to a patient's maxillary and mandibular dentitions;
fabricating an upper shell for the patient's maxillary dentition and a lower shell for the patient's mandibular dentition based upon the electronic information, each of the shells formed of a first material and having a channel therein, a coupling device being provided on the upper shell and the lower shell for maintaining the lower shell in a forwardly protruded position with respect to the upper shell when taken in relation to the corresponding natural position of the patient's mandibular and maxillary dentitions;
supplying a moldable second material to the channels; and
shaping the moldable second material to substantially conform to the patient's maxillary and mandibular dentitions.

2. The method according to claim 1, wherein the step of shaping the moldable second material is performed by placing the moldable second material over the patient's teeth or by placing the moldable second material over a model of the patient's teeth.

3. The method according to claim 1, wherein the step of acquiring information relating to a patient's maxillary and mandibular dentitions in electronic form is performed by (a) taking a three-dimensional scan of the patient's oral cavity or (b) taking digital photographs of a dental model.

4. The method according to claim 1, wherein the electronic information is transmitted to a third party.

5. The method according to claim 4, wherein the third party fabricates the upper and lower shells.

6. The method according to claim 1, wherein the step of fabricating an upper shell and a lower shell based upon the electronic information comprises defining upper and lower shell parameters.

7. The method according to claim 6, wherein the step of defining upper and lower shell parameters is performed by a computer program upon receiving the electronic information.

8. The method according to claim 6, wherein a milling machine receives the upper and lower shell parameters and mills the upper shell out of a generic upper shell template and the lower shell out of a generic lower shell template.

9. The method according to claim 8, wherein first and second retention elements of the coupling device are secured to the respective generic templates prior to milling.

10. The method according to claim 6, wherein the step of fabricating an upper shell and a lower shell based upon the electronic information comprises the steps of:
producing an upper mold and a lower mold for shaping the first material according to the defined upper and lower shell parameters; and
injecting the first material into the upper and lower molds to form the upper and lower shells.

11. The method according to claim 1, wherein the coupling device is positioned based upon the electronic information.

12. The method according to claim 1,
wherein the coupling device comprises:
(1a) an upper retention element secured to the upper shell,
(2a) a lower retention element secured to the lower shell,
(3a) a guide box, and
(4a) a stylus, wherein the guide box is connected to one of the upper retention element or the lower retention element, the stylus is connected to the other of the upper retention element or the lower retention element, the guide box and the stylus configured to engage each other to provide lateral relative movement between the upper shell and the lower shell; or
wherein the coupling device comprises:
(2a) an upper flange extending from the upper shell, and
(2b) a lower flange extending from the lower shell, wherein the upper flange and the lower flange engage each other to maintain the lower shell in the forwardly protruding position; or
wherein the coupling device comprises:
(3a) a post extending from one of the upper shell or the lower shell, the post engaging the other of the upper shell or the lower shell to maintain the lower shell in the forwardly protruding position; or
wherein the coupling device comprises:
(4a) elastic bands biased to urge the lower shell forwardly.

13. The method according to claim 1, wherein the coupling device connects, at one end, to a forward region of one of the upper shell or the lower shell and, at another end, the coupling device connects to a rearward region of the other of the upper shell or the lower shell.

14. The method according to claim 1, wherein the coupling device is (a) separately formed and secured to the upper shell and the lower shell by a fastening mechanism, or (b) integrally formed with one or both of the upper shell and the lower shell.

15. The method according to claim 1, wherein the coupling device is a Halstrom hinge, a Thornton device, a Lowe device, a Palmisano device, Frantz device, or any combination thereof.

16. A method of forming a mandibular advancement device comprising:
acquiring electronic information relating to a patient's maxillary and mandibular dentitions; and
fabricating an upper bite block for the patient's maxillary dentition and a lower bite block for the patient's mandibular dentition based upon the electronic information, a coupling device being provided on the upper bite block and the lower bite block for maintaining the lower bite block in a forwardly protruded position with respect to the upper bite block when taken in relation to the corresponding natural position of the patient's mandibular and maxillary dentitions.

17. The method according to claim 16, wherein the bite block is formed out of a single material.

18. The method according to claim 16, wherein the bite block is formed out of at least a hard acrylic and a soft acrylic.

19. The method according to claim 16, wherein the step of acquiring information relating to a patient's maxillary and mandibular dentitions in electronic form is performed by (a) taking a three-dimensional scan of the patient's oral cavity or (b) taking digital photographs of a dental model.

20. The method according to claim 19, wherein the electronic information is transmitted to a third party.

21. The method according to claim 20, wherein the third party fabricates the upper and lower bite blocks.

22. The method according to claim 16, wherein the step of fabricating an upper bite block and a lower bite block based upon the electronic information comprises defining parameters.

23. The method according to claim 22, wherein the step of defining parameters is performed by a computer program upon receiving the electronic information.

24. The method according to claim 22, wherein a milling machine receives the defined parameters and mills at least part of the upper bite block out of a generic upper template and at least part of the lower bite block out of a generic lower template.

25. The method according to claim 24, wherein first and second retention elements of the coupling device are secured to the respective generic templates prior to milling.

26. The method according to claim 22, wherein the step of fabricating an upper bite block and a lower bite block based upon the electronic information comprises the steps of:
producing an upper mold and a lower mold for shaping a material according to the defined parameters; and
injecting the material into the upper and lower molds to form at least part of the upper and lower bite blocks.

27. The method according to claim 16, wherein the coupling device is positioned based upon the electronic information.

28. The method according to claim 16,
wherein the coupling device comprises:
(1a) an upper retention element secured to the upper bite block,
(1b) a lower retention element secured to the lower bite block,
(1c) a guide box, and
(1d) a stylus, wherein the guide box is connected to one of the upper retention element or the lower retention element, the stylus is connected to the other of the upper retention element or the lower retention element, the guide box and the stylus configured to engage each other to provide lateral relative movement between the upper bite block and the lower bite block; or
wherein the coupling device comprises:
(2a) an upper flange extending from the upper bite block, and
(2b) a lower flange extending from the lower bite block, wherein the upper flange and the lower flange engage each other to maintain the lower bite block in the forwardly protruding position; or
wherein the coupling device comprises:
(3a) a post extending from one of the upper bite block or the lower bite block, the post engaging the other of the upper bite block or the lower bite block to maintain the lower bite block in the forwardly protruding position; or
wherein the coupling device comprises:
(4a) elastic bands biased to urge the lower shell forwardly.

29. The method according to claim 16, wherein the coupling device connects, at one end, to a forward region of one of the upper bite block or the lower bite block and, at another end, the coupling device connects to a rearward region of the other of the upper bite block or the lower bite block.

30. The method according to claim 16, wherein the coupling device is (a) separately formed and secured to the upper bite block and the lower bite block by a fastening mechanism, or (b) integrally formed with one or both of the upper bite block and the lower bite block.

31. The method according to claim 16, wherein the coupling device is a Halstrom hinge, a Thornton device, a Lowe device, a Palmisano device, Frantz device, or any combination thereof.
